(19) United States
(12) Patent Application Publication
(10) Pub. No.: US 2008/0149236 A1
(43) Pub. Date: Jun. 26, 2008

(54) Pneumatic tire

(76) Inventors: Gia Van Nguyen, Blagny (FR); Anne-France Gabrielle Jeanne-Marie Cambron, Petange (LU); Frank Pierre Severens, Arlon (BE); Raymound Marie Joseph Ghislain Houba, Vaux-sur-Sure (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/643,149

(22) Filed: Dec. 21, 2006

(51) Int. Cl. B60C 11/24

(52) U.S. Cl. 152/154.2

(57) ABSTRACT

A pneumatic tire has a tread with plurality of grooves creating tread elements therein and defining a non-skid tread depth measured from the radially outer surface of the tread to the radially innermost surface of the grooves. Groove voids are located radially inward of the tread surface. The groove voids do not extend to the unworn tread surface and have a primary axis of orientation along the circumferential length of the tread. The primary axis of orientation of the groove voids is 0°-35° relative to the equatorial plane of the tire. The groove voids are aligned such that, when the tire tread is worn to a depth wherein the groove voids are exposed, a groove is created in the tread. The created groove extends in the circumferential direction and has a circumferential length greater than the length between the leading and trailing edges of the tread footprint.

### FIELD OF THE INVENTION

The present invention relates to a pneumatic tire, and more particularly to a tread of a pneumatic tire wherein the tread is configured to provide a different tread pattern as the tire is worn.

### BACKGROUND OF THE INVENTION

Tire tread patterns are provided with numerous elements such as ribs and blocks, the elements being separated by circumferential and/or transverse grooves. The grooves provide means for water evacuation and form the biting edges of the tread elements.

When a tire is new, the tread has a maximum tread height. This initial height may vary depending upon the intended use of the tire; a winter tire has an increased tread depth in comparison to an all season tire. Regardless of the initial tread depth, when the tire is new, the tread elements have an initial stiffness. The actual stiffness of the tread elements is dictated by the block size, shape, and the presence of any siping. As the tread is worn, the block height decreases while the tread element stiffness increases.

When a tire travels through water, two mechanisms occur: water force-back and water flow through the grooves. The water force back mechanism is always present. However, for a smooth tire, above a particular vehicle speed and water depth, a water bank is formed in front of the footprint leading edge. Slippage between the tire and the road surface will occur unless the water bank is reduced by water flow through the grooves, carrying the water through the footprint. In a new tire, there may be a compromise in the tread pattern between stiffness and wet driving performance. In such a new tire, the water force back mechanism and the non-skid tread depth is sufficient to provide for acceptable aquaplaning resistance. As the tire wears and the non-skid depth reduces, the water flow through the grooves is reduced. The present invention is directed to a tire having a tread that compensates for this reduced flow.

### SUMMARY OF THE INVENTION

Disclosed herein is a pneumatic tire. The tire is designed to have a variable tread pattern, the tread pattern changing with wear, to achieve similar tread performance for the tire when both new and worn. The changing pattern optimizes the worn tire performance in an attempt to maintain the tire's wet performance characteristics.

It is an object of the invention to have a tire tread pattern wherein, with tire wear, new or additional grooves joining the footprint leading and trailing edges appear in the tread. Such new or additional grooves should be free of flow obstacles such as tie-bars or other obstructions.

Disclosed herein is a pneumatic tire, the tire having an equatorial plane. The tire has a tread, the tread having a footprint and the footprint has a leading and trailing edge. The tread has a plurality of grooves creating tread elements therein and defining a non-skid tread depth measured from the radially outer surface of the tread to the radially innermost surface of the grooves. Groove voids are located radially inward of the initial, or unworn, tread surface; thus the groove voids are buried in the non-skid tread depth. The groove voids have opposing circumferential ends and a primary axis of orientation along the circumferential length of the tread. The axis of orientation of the groove voids are within the range of 0°-35° relative to an equatorial plane of the tire. The circumferential ends of the groove voids are aligned such that, when the tire tread is worn to a depth wherein the groove voids are exposed, a groove is created in the tread. The created groove extends in the circumferential direction and has a circumferential length greater than the length between the leading and trailing edges of the tread footprint.

In another aspect of the invention, the groove voids have an axis of orientation of zero degrees relative to the equatorial plane of the tire.

In another aspect of the invention, the base of the groove void and the base of the grooves are located at the same radial depth of the tire tread. Also, the groove void has a height of 30 to 70% of the non-skid tread depth.

In one aspect of the invention, the tire tread has groove voids therein such that when the tread is worn and the groove voids are exposed, there are at least two circumferentially extending and continuous grooves created in the tread. Alternatively, the worn tread has at least one or two created grooves on each side of the equatorial plane of the tire.

### Definitions

The following definitions are controlling for the disclosed invention.

“Axial” and “axially” are used herein to refer to lines or directions that are parallel to the axis of rotation of the tire.

“Circumferential” means lines or directions extending along the perimeter of the surface of the annular tire parallel to the Equatorial Plane (EP) and perpendicular to the axial direction.

“Groove” means an elongated void area in a tread that may extend circumferentially or laterally about the tread in a straight, curved, or zigzag manner. Circumferentially and laterally extending grooves sometimes have common portions and may be sub classified as “wide” or “narrow.” A “narrow groove” has a width in the range from about 0.8% to 3% of the compensated tread width and a “wide groove” has a width greater than 3% thereof. The “groove width” is equal to tread surface area occupied by a groove or groove portion, the width of which is in question, divided by the length of such groove or groove portion; thus, the groove width is its average width over its length. Grooves reduce the stiffness of tread regions in which they are located. Grooves may be of varying depths in a tire. The depth of a groove may vary around the circumference of the tread, or the depth of one groove may be constant but vary from the depth of another groove in the tire.

“Inner” means toward the inside of the tire and “outer” means toward its exterior.

“Lateral” means an axial direction.

“Nonskid” means the depth of grooves in a tire tread.

“Radial” and “radially” are used to mean directions radially toward or away from the axis of rotation of the tire.

“Sipe” means a void area in a tread that may extend circumferentially or laterally in the tread in a straight, curved, or zigzag manner. A sipe typically is formed by steel blades inserted into a cast or machined mold or tread ring therefor. In the appended drawings, excluding close up drawings, sipes are illustrated by single lines because they are so narrow. A “sipe” is a groove having a width in the range from about 0.2% to 0.8% of the compensated tread width.

### BRIEF DESCRIPTION OF THE DRAWINGS

The invention will be described by way of example and with reference to the accompanying drawings in which:

FIG. 1 is a perspective view of an unworn tire;

FIG. 1A is an enlarged view of section 1A from FIG. 1;

FIG. 2 is a perspective view of a tire following wear of the tire tread;

FIG. 2A is an enlarged view of section 2A from FIG. 2;

FIG. 3 is a flat view of the tread of FIG. 1;

FIG. 4 is a flat view of the tread of FIG. 2;

FIG. 5 is a cross-sectional view along line 5-5 of FIG. 3;

FIG. 6 is a cross-sectional view along line 6-6 of FIG. 4;

FIG. 7 is a perspective view of one pitch design of the unworn tread of FIG. 1;

FIG. 8 is an unworn tire tread illustrating another embodiment; and

FIG. 9 is a flat view of the tread of FIG. 8 following wear of the tread.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

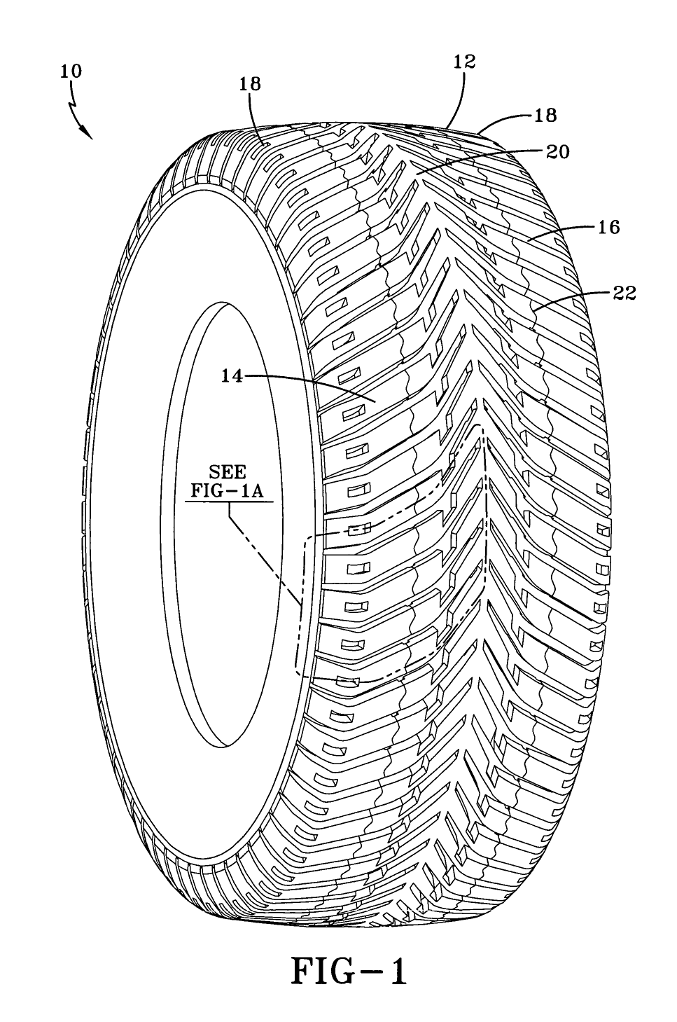

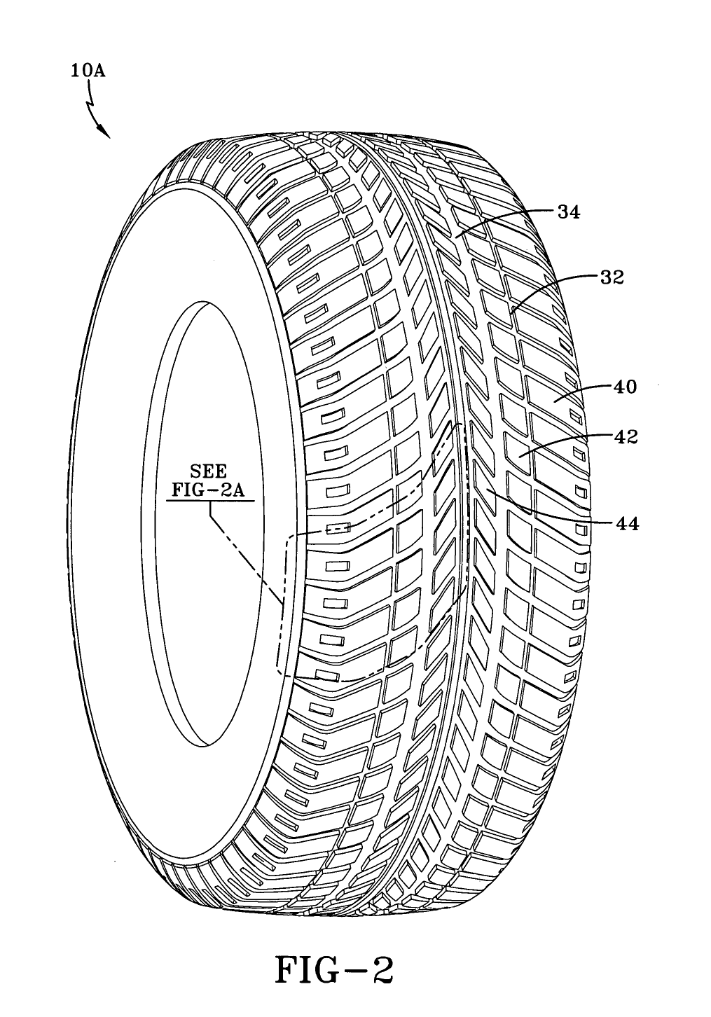

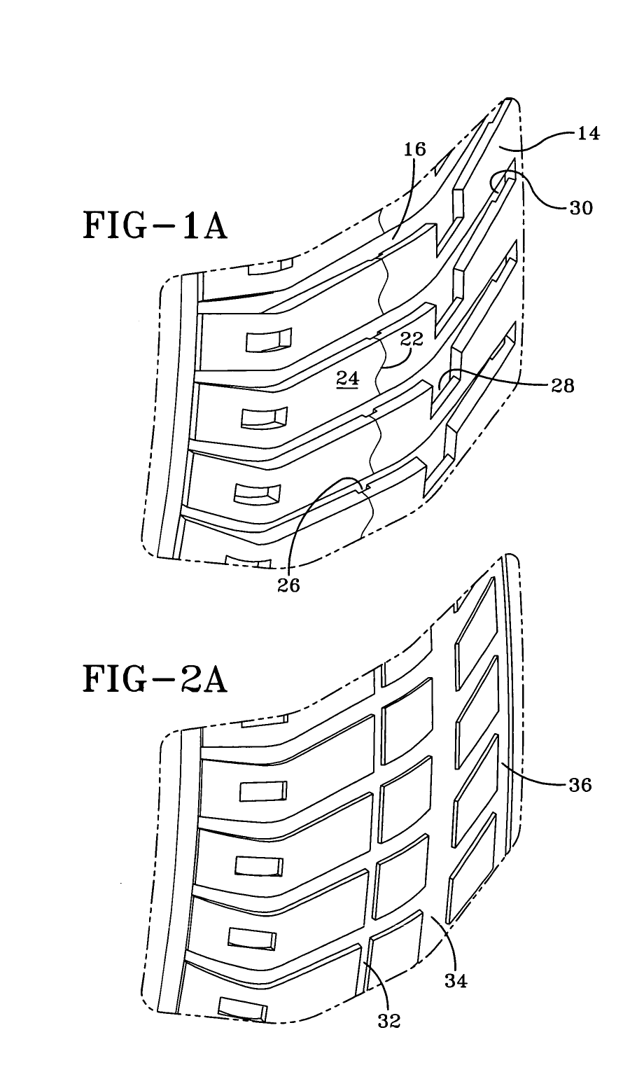

A tire is illustrated in FIG. 1. The tire 10 has a tread 12 comprising a plurality of tread elements 14 separated by inclined lateral grooves 16. The tread elements 14 extend continuously between the tread shoulders 18. Circumferentially adjacent tread elements 14 are connected in the region of the tire equatorial plane EP, creating a quasi rib 20 in the tread, see also FIG. 3. The tread 14 is also provided with sipes 22 that extend between the circumferentially adjacent lateral grooves.

Radially inward of the tread surface 24 are a plurality of groove voids. In the tread of FIG. 1, in each design pitch, extending between a tread shoulder edge and the equatorial plane, radially inward of the tread surface 24 of each tread element are three groove voids 26, 28, 30, see FIGS. 1A, 5, and 7. The groove voids have a primary axis of orientation along the circumferential length of the tire. This axis of orientation is inclined at an angle of 0° to 35° relative to the equatorial plane of the tire. The groove voids 26, 28, 30 also have opposing circumferential ends 26E, 28E, 30E, coincident with the lateral grooves 16. Groove voids 26 have a construct of a type that may be identified as a sipe-groove, wherein, at the tread surface, there is a sipe and at a defined depth of the tread, the sipe transforms to a groove void. As the respective groove voids 26, 28, 30 in circumferentially adjacent tread elements 14 are circumferentially aligned, the groove voids 26, 28, 30 create multiple tunnel-like features in the tread 12.

However, as there is tread rubber located above each groove void, when the tread is unworn or has been subjected to a limited amount of tread wear, an obstruction is created in what may be considered a water flow channel. Due to the absence of continuous unobstructed circumferential grooves, the main water flow mechanism that occurs in the tread of FIG. 1 is water force back.

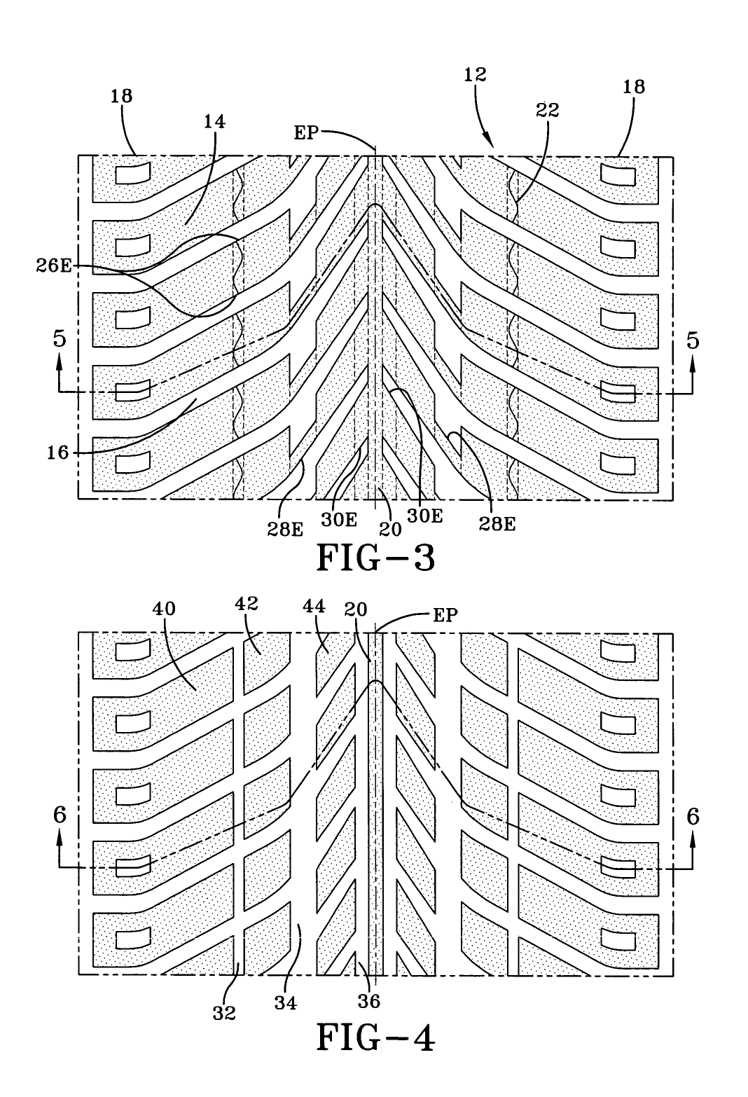

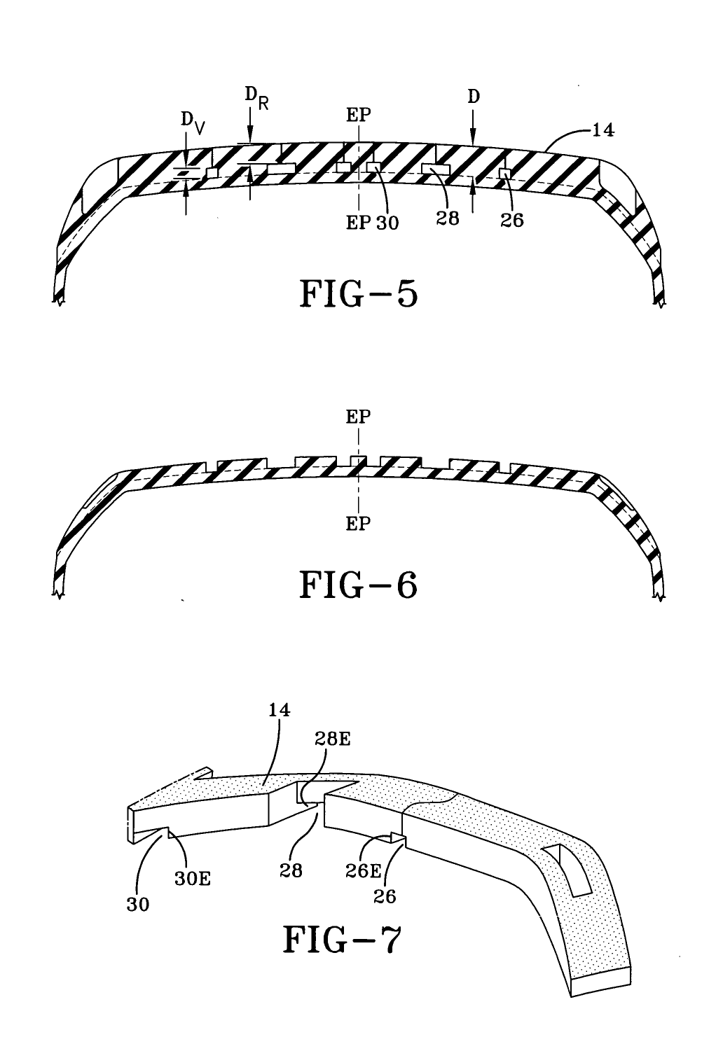

The tread 14 has an initial non-skid tread depth D calculated between the tread surface of the tire when unworn, and the radially innermost base of a groove in the tread, see FIG. 5. As the tread 14 wears, the non-skid tread depth D is reduced, and the groove voids 26, 28, 30 are exposed, creating new unobstructed circumferential grooves 32, 34, 36 in the tread, see FIGS. 2, 4, and 6; hence the term “groove void.” A groove void is a the tread feature that is an void to the initial tread surface that generates a groove when exposed; thus the groove void has a width in the range of groove widths as defined above. Exposure of the groove voids is based upon the radial depth DR of the rubber above the groove voids. The rubber radial depth DR is 30% to 70% of the full nonskid D; thus the grooves are exposed anywhere from 30 to 70% wear of the full tread depth D. The groove voids 26, 28, 30 ideally also have a radially innermost base aligned at the same tread radial depth as the grooves 16. The circumferential grooves 32, 34, 36 transform the tread of FIG. 1 from one of connected tread elements 14 to a tread having a plurality of non-connected tread blocks 40, 42, 44 located on each side of a center rib 20.

As seen in FIG. 5, the portions of tread rubber radially outward of each groove void all have the same rubber radial depth; i.e. all of the groove voids 26, 28, 30 have the same groove void depth DV. For groove voids 26, that have a sipe component located radially outward thereof, connecting it to the tread surface, the void depth DV, is measured for only that portion of the void which has a width within the definition of a groove width; this is best illustrated in FIG. 5. However, to gradually increase the amount of unobstructed circumferential grooving in the tread, the groove void depths DV may vary. The variation may be selected based upon the axial position of the groove in the tread or the total cross-sectional area of the groove void. For example, if based upon the axial position of the to-be-created groove, it may be desired to have the axially outermost grooves 32 appear before the grooves 36 located nearest the equatorial plane. For such a tread variation, the groove void depth DV of the axially outermost groove void 26 is greater than the groove void depth of the axially inner groove void 30. If it is desired that the groove voids have a constant cross sectional area, the axially wider groove voids would have a reduced groove void depth DV in comparison to the other groove voids. Alternatively, the groove voids may be placed such that the radial depth D_{R} of the rubber above the groove voids 26, 28, 30 is constant, while the groove void depths D_{V} are varied. Such a tread results in varying depths to the exposed grooves, creating more cross-sectional area through which the water may flow.

As the new grooves 32, 34, 36 are continuous, as the tire travels through water, water is free to flow unobstructed from the leading edge of the footprint to the trailing edge of the footprint. To improve water flow in the worn tire tread, it is one aspect of the invention that the newly created grooves fully extend between the leading and trailing footprint edges, contacting, and preferably extending beyond, the leading and trailing edges of the tire footprint.

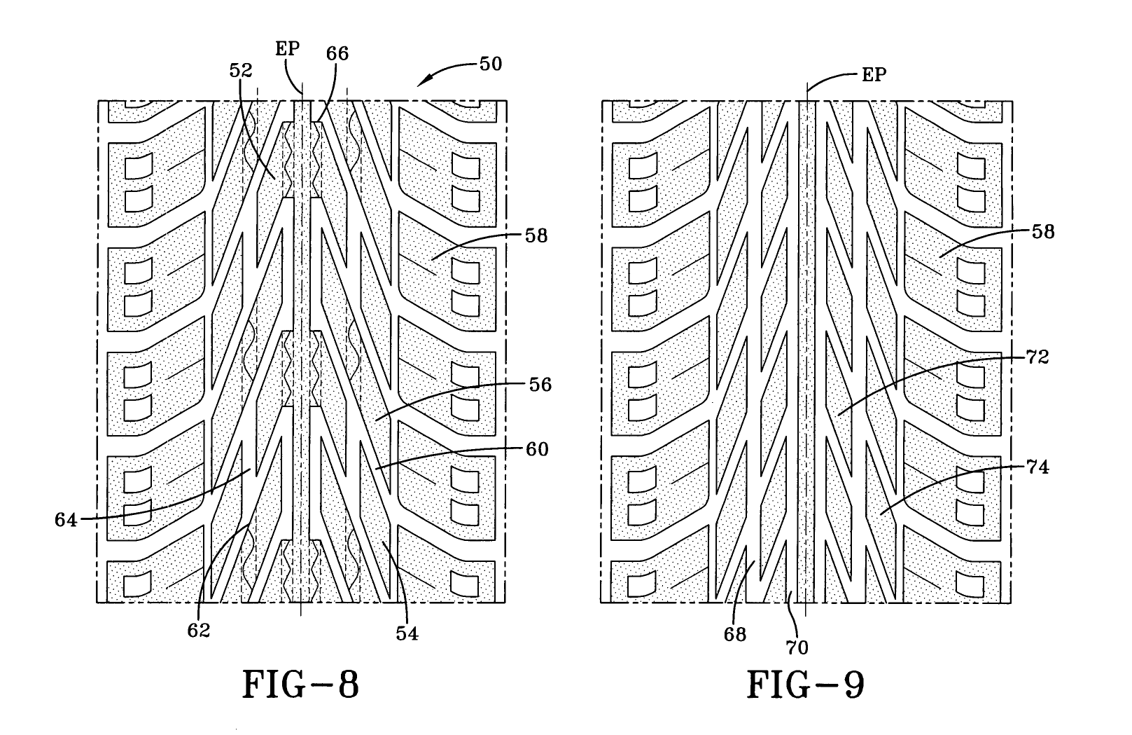

An alternative embodiment of the tire tread is shown in FIGS. 8 and 9. The tread 50 of FIG. 8 is that of an unworn tread. The tread has a combination of connected circumferentially adjacent tread elements 52 creating a rib-like feature at the tire equatorial plane EP. On each lateral side of the central rib-like tread feature is a row of alternating width tread blocks 54, 56. Axially outward of this row of tread blocks is a shoulder row of tread blocks 58. The alternating width tread blocks 54, 56 and shoulder tread blocks 58 are separated by inclined lateral grooves 60. Separating the two rows of blocks is a continuous, non-obstructed circumferential groove.

In the row of alternating width blocks, the greater width blocks 56 are provided with a groove void 62. The groove void 62 is aligned with a short length circumferential groove 64. In the central rib-like feature, groove voids 66 are provided on each side of the equatorial plane EP. As the tread wears, continuous unobstructed circumferential grooves 68, 70 are generated as the rubber above the groove voids 62, 66 is worn away. This results in two rows 72, 74 of individual blocks between a center rib and the shoulder blocks 58. A tread of lower net-to-gross with an increased number of continuous unobstructed circumferential grooves is generated.

While two definitive embodiments of the tread have been provided, other tread element configurations are conceivable wherein the aspects of the creation of an increased number of continuous unobstructed circumferential grooves are met. Such other tread embodiments may include tread configurations wherein a groove void, as described above, is located on the equatorial plane of the tire.

What is claimed is:

1. A pneumatic tire, the tire having an equatorial plane, a tread, and a footprint having a leading and trailing edge, the tread comprising grooves therein, the grooves forming tread elements, the tread having a radially outer surface and a non-skid tread depth measured from the radially outer surface of the tread and a radially innermost surface of the grooves, and groove voids being located radially inward of the initial tread surface, the tire being characterized by the voids having opposing circumferential ends and a primary axis of orientation along the circumferential length of the tread, said axis of orientation being inclined at 0°-35° relative to an equatorial plane of the tire, and the circumferential ends of the groove voids being aligned such that, when the tire tread is worn to a depth wherein the groove voids are exposed, a groove is created in the tread, the created groove extending in the circumferential direction and having a circumferential length greater than the length between the leading and trailing edges of the tread footprint.

2. The tire of claim 1 wherein the groove void has an axis of orientation of zero degrees relative to the equatorial plane of the tire.

3. The tire of claim 1 wherein the base of the groove void and the base of the grooves are located at the same radial depth of the tire tread.

4. The tire of claim 1 wherein the groove void has a height of 30 to 70% of the non-skid tread depth.

5. The tire of claim 1 wherein the tire tread has groove voids therein such that when the tread is worn and the groove voids are exposed, at least two circumferentially extending and continuous grooves are created.

6. The tire of claim 1 wherein the tire tread has groove voids therein such that when the tread is worn and the groove voids are exposed, at least one groove on each side of the equatorial plane of the tire is created.

7. The tire of claim 1 wherein the tire tread has groove voids therein such that when the tread is worn and the groove voids are exposed, at least two grooves on each side of the equatorial plane of the tire are created.

8. The tire of claim 1 wherein the tread is comprised of lateral grooves and each circumferential end of the groove voids is coincident with a lateral groove.
